(19) United States
(12) Patent Application Publication
(10) Pub. No.: US 2026/0057704 A1
(43) Pub. Date: Feb. 26, 2026

(54) ENHANCED VISITOR MANAGEMENT SYSTEM WITH ASSISTANCE FOR PHYSICALLY CHALLENGED INDIVIDUALS

(71) Applicant: Honeywell International Inc., Charlotte, NC (US)

(72) Inventor: Anitha Eswari, Madurai (IN)

(21) Appl. No.: 18/811,375

(22) Filed: Aug. 21, 2024

(51) Int. Cl. G06V 40/20; G06V 10/764; G06V 20/60; G07C 9/20

(52) U.S. Cl. CPC G06V 40/25; G06V 10/764; G06V 20/60; G07C 9/20

(57) ABSTRACT

Systems, methods and software products directed to allowing a user to access a facility or other controlled space using credentials. The user is queried as to whether the user has impaired mobility. In response to an affirmative response to the query, the user's status is confirmed such as by reference to security camera data to confirm the user's impaired mobility. If the user is confirmed as having mobility, a special access card and assistance are provided to the user by the security or access control system and, otherwise, a normal access card is provided.

### BACKGROUND

When a physically challenged individual visits a facility, they may have specific needs. For example, standard automatic doors may open and close too quickly, and the person may need information on the location of wheelchair-accessible ramps or stairs, designated restrooms, and other facilities tailored to their requirements. New and alternative systems and methods for accommodating individuals with physical disabilities are desired.

### OVERVIEW

The present inventors have recognized, among other things, that a problem to be solved is the need for new and/or alternative systems and methods for accommodating individuals with physical disabilities are desired.

An illustrative, non-limiting example takes the form of a security system comprising a kiosk configured for receiving and verifying credentials and issuing access cards, the kiosk having or in communicative link to database for facility data and a controller configured to perform analysis functions; a camera for observing a visitor; and at least one access control. In the example, the security system is configured for receiving, at the kiosk, a set of access credentials from a visitor; accepting the access credentials to grant access to a limited access area if the access credentials are valid; presenting, from the kiosk, a query to the visitor asking whether the visitor has impaired mobility; receiving, at the kiosk, a response from the visitor to the query asking whether the visitor has impaired mobility; if the visitor gave a negative response, issuing a normal access card for the visitor; if the visitor gave an affirmative response, next confirming, by analysis of data from the camera, whether the visitor has impaired mobility; and if the visitor is confirmed to have impaired mobility, configuring a special access card for the visitor and issuing the special access card for the visitor; wherein the access control controls opening a door, holding the door open for a predetermined period of time, and closing the door; wherein the access control responds to the special access card by using a first predetermined period of time and the access control responds to the normal access card by using a second predetermined period of time, the second predetermined period of time being shorter than the first predetermined period of time.

Additionally or alternatively, if the visitor is confirmed to have impaired mobility, generating and communicating to the visitor a video illustrating a manner of accessing and passing through the limited access area tailored to the visitor having impaired mobility. Additionally or alternatively, the security system is configured to use an artificial intelligence to analyze the data from the camera to confirm whether the visitor has impaired mobility. Additionally or alternatively, the security system is configured to use an object recognition to analyze the data from the camera to confirm whether the visitor has impaired mobility, the object recognition configured to identify a mobility assistance device.

Additionally or alternatively, the security system is configured to analyze one or more of gait or speed of the visitor using the data from the camera to confirm whether the visitor has impaired mobility. Additionally or alternatively, the security system is configured to issue the normal access card in response to the visitor giving an affirmative response to the query and the security system not confirming that the visitor has impaired mobility. Additionally or alternatively, the special access card is a physical access card, and the kiosk includes an encoder for writing data to the physical access card.

Additionally or alternatively, the special access card is a virtual access card, and the kiosk is configured to communicate credentials for the special access card to a mobile device of the visitor. Additionally or alternatively, the special access card takes the form of data accompanying biometric data of the visitor, and the kiosk is configured to issue the special access card for the visitor by communicating the biometric data and special access data for the visitor to the access control.

Another illustrative and non-limiting example takes the form of a method of operating a security system comprising: receiving a set of access credentials from a visitor; accepting the access credentials; presenting a query to the visitor asking whether the visitor has impaired mobility; receiving a response from the visitor indicating impaired mobility; in response to the visitor indicating impaired mobility, next analyzing whether the visitor has impaired mobility by analysis of data from a security camera; confirming the visitor has impaired mobility and, in response, configuring a special access card for the visitor and issuing the special access card for the visitor; receiving, at an access control, a request to access from the visitor to whom the special access card was issued, wherein the access control controls: opening a door; holding the door open for a first predetermined period of time for a normal access card, or holding the door open for a second predetermined period of time for the special access card, the second predetermined period of time being longer than the first predetermined period of time; and closing the door; and the access control opening the door for the second predetermined period of time in response to the visitor's request for access.

Additionally or alternatively, the method includes, along with issuing the special access card to the visitor, generating and communicating to the visitor a video illustrating a manner of accessing and passing through the limited access area tailored to the visitor having impaired mobility. Additionally or alternatively, the step of analyzing whether the visitor has impaired mobility is performed by using an artificial intelligence for pattern recognition. Additionally or alternatively, the step of analyzing whether the visitor has impaired mobility is performed by object recognition configured to identify a mobility assistance device. Additionally or alternatively, the step of analyzing whether the visitor has impaired mobility is performed by analyzing one or more of gait or speed of the visitor using the data from the camera.

Additionally or alternatively, the special access card is a physical access card, and the method further comprises using an encoder to write data to the physical access card to make the physical access card a special access card. Additionally or alternatively, the special access card is a virtual access card, and the method further comprises communicating for the special access card to a mobile device of the visitor. Additionally or alternatively, the special access card takes the form of data accompanying biometric data of the visitor, and the method further comprises communicating the biometric data and special access data for the visitor to the access control.

Another illustrative and non-limiting example takes the form of a non-transitory computer readable medium storing instructions for execution by a security system comprising a kiosk configured for receiving and verifying credentials and issuing access cards, the kiosk having or in communicative link to database for facility data and a controller configured to perform analysis functions, a camera for observing a visitor, and at least one access control; the instructions, when executed, causing the system to: receive, at the kiosk, a set of access credentials from a visitor; accept the access credentials to grant access to a limited access area if the access credentials are valid; present, from the kiosk, a query to the visitor asking whether the visitor has impaired mobility; receive, at the kiosk, a response from the visitor to the query asking whether the visitor has impaired mobility; if the visitor gave a negative response, issuing a normal access card for the visitor; if the visitor gave an affirmative response, next confirm, by analysis of data from the camera, whether the visitor has impaired mobility; and if the visitor is confirmed to have impaired mobility, configure a special access card for the visitor and issue the special access card for the visitor; wherein the access control controls opening a door, holding the door open for a predetermined period of time, and closing the door; wherein the access control responds to the special access card by using a first predetermined period of time and the access control responds to the normal access card by using a second predetermined period of time, the second predetermined period of time being shorter than the first predetermined period of time.

Additionally or alternatively, the instructions, when executed, further cause the system to generate and communicate to the visitor a video illustrating a manner of accessing and passing through the limited access area tailored to the visitor having impaired mobility if the visitor is confirmed to have impaired mobility. Additionally or alternatively, the instructions when executed, cause the security system to use an artificial intelligence to analyze the data from the camera to confirm whether the visitor has impaired mobility.

This overview is intended to provide an introduction to the subject matter of the present patent application. It is not intended to provide an exclusive or exhaustive explanation. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows an illustrative security system;

FIG. 2 illustrates in block form steps of a method;

FIG. 3 illustrates in block form steps for confirming a user type;

FIG. 4 illustrates in block form access control methods; and

FIG. 5 illustrates in block form a method for visitor assistance.

### DETAILED DESCRIPTION

In an example, a facility (such as a building or collection of buildings) may have a kiosk for checking in, presenting credentials, and obtaining a keycard (physical or virtual) to allow the person to enter and move about within the facility. In an illustrative example, when a visitor presents their credentials, such as a QR code, identification, or a device, at the kiosk, the security system controlling the kiosk determines whether the visitor is authorized to enter. If so, the security system then presents a query regarding whether the person has a physical disability and requires assistance or accommodation.

If the visitor answers “Yes” to the query, the security system may obtain additional data, such as a video feed or other visual data, to confirm whether or not the visitor is in fact physically disabled and needs the requested accommodation. Such additional data may be obtained, for example, from a security camera. In an example, a security camera feed, whether stored, for example, in a FIFO video loop, or obtained after the visitor answers the query, is analyzed using, for example, an object recognition system (to identify mobility assistance items used by the person, such as a cane, crutches, a walker or a wheelchair, etc.), and/or movement analysis system (to determine gait, speed of movement, etc.). In some examples, an artificial intelligence (AI) may be used to determine whether or not the person is in fact physically disabled, and/or has limited mobility.

If the security system confirms that the person has limited mobility, a special keycard is issued to the person which is encoded with information that will indicate to, for example, access controls, that the person has limited mobility. When the special keycard is presented at an access control, default settings may be adjusted to, for example, extend the duration for which a door is held open by an automated door opening/closing system. In addition to issuing the special keycard, the kiosk may also provide instructions to the visitor for accessing and/or finding facilities that the visitor may need, such as handicap accessible ramps, stairs, elevators and/or restrooms. Such instructions may take the form of a map, a set of text-based instructions, an audio instruction, and/or a video simulation of a path the visitor may follow. Instructions may be presented by the kiosk and/or may be sent to a user mobile device (such as a smartphone) by text message, email, direct download (video sharing), or any other suitable sharing system.

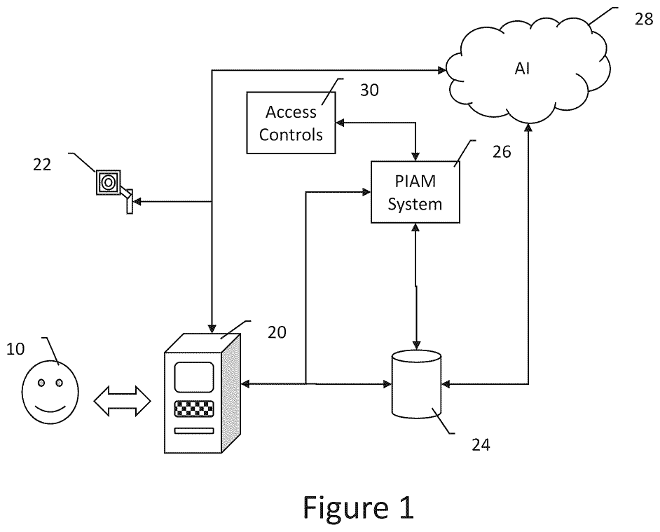

FIG. 1 shows an illustrative system. A visitor 10 interacts with a kiosk 20 that is part of the physical identity and access management (PIAM) system 26, which can be referred to generally as a security system herein. A database 24 stores data of various types, including data for authorized access so that when visitor 10 presents herself at the kiosk 20, the PIAM system 26 determines whether the visitor's access is authorized. If the visitor 10 is authorized, the kiosk 20 presents a query regarding the person's mobility or other handicapped or disability status. The database may also store pattern matching data, which may be used as discussed further below.

If the visitor 10 indicates a limited mobility or mobility related handicap to the kiosk 20, additional information is reviewed to confirm the visitor's answer. For example, a security camera 22 captures images, individually and/or as video clips. Those images and/or other data are reviewed in the PIAM system 26, which may use an AI-generated patterns to confirm (or not) the visitor 10 having limited mobility. Audio may be captured as well, and the security camera 22 may in fact be multiple devices capturing images, audio, etc. Infrared as well as visible light cameras can be used, if desired.

Stored pattern data may be in the database 24, for example. Patterns to match may include individual images, such as of a wheelchair, crutches, a walker, or other mobility aids. Indications of limited mobility may be assessed, such as by using image matching to determine if the visitor is wearing a cast on a lower limb, for example and without limitation. Patterns may also be based on multiple images in series, that is, video. For example, motion analysis may be used to determine gait, stability, balance, tremor, walking speed, or other factors. Irregularity of movement may, for example, indicate a limp suggesting limited mobility. Slow or uneven gait can also be used to indicate limited mobility. The ability and/or speed with which a step, stairs, and/or a turn or corner is traversed by the visitor may be used to identify a person having limited mobility. Particular movements, for example, a swinging motion associated with the use of crutches, may be identified using pattern matching, such as by the use of AI analytics trained with other videos of persons using crutches. AI analytics may also be trained using video of other persons having various mobility impairments.

In some examples, the kiosk 20 may also include a camera allowing closer images of the visitor to be analyzed. For example, certain tremors indicative of potential movement disorders may be apparent from close-in video, such as facial images, captured while the visitor is present at the kiosk. In addition to pattern data, heat signature data could be used, for example, an individual having a prosthetic limb may present differently on infrared imaging than a person having a natural limb. Thus, for example, a person walking more or less normally, or at least with a gait of sufficient speed and stability that gait analysis or speed analysis would not support a finding of reduce mobility, may still be identified as having limited mobility by the use of an infrared imaging analysis to identify the prosthetic limb.

The kiosk 20 is then used to generate and provide to the visitor 10 an access card. The access card may be a physical access card, or may be a set of access credentials that can be loaded onto the visitor's mobile device (such as a smartphone). In some examples, no access card is needed and instead the kiosk 20 obtains image, voice or other data (biometric data for example) from the visitor which is then used at access locations in the facility to confirm identify of the visitor 10. If biometric data is obtained and used by the security system for access control, credentials accompanying the biometric data may indicate the user's special access privileges as discussed below.

The security system 26 is operably linked to one or more access controls 30. The access controls 30 may include, for example, card readers and associated locks or automatic doors, elevator controls, etc. A card reader can be used in the access control 30 to read an access card (if physical cards are used) or a virtual card in a visitor's smartphone (if used), and determine whether the visitor is authorized to enter through the access control 30.

The access card or access credentials of visitor 10 depend on the confirmation of the visitor's assertion of limited mobility. If the visitor 10 is determined to be physically disabled or having limited mobility, a special access card or credentials are generated for the visitor to use when moving throughout the facility. Otherwise, a normal access card or credentials are generated for the visitor. Access that is then provided depending on the access card or credential type. A special access card or credentials may be used to hold open an automatic door, for example, for a period of time which is longer than the period used when a normal access card or credentials are used to access the door. In other examples, elevator calls may be triggered by the type of access card or credentials. For example, if an escalator and an elevator are both available at a given location, the elevator may be called to the floor the visitor 10 is on as the visitor 10 approaches the escalator and elevator, to reduce waiting time for the visitor on reaching the location in question, as it will be expected that the visitor would go to the elevator. Various use cases can apply.

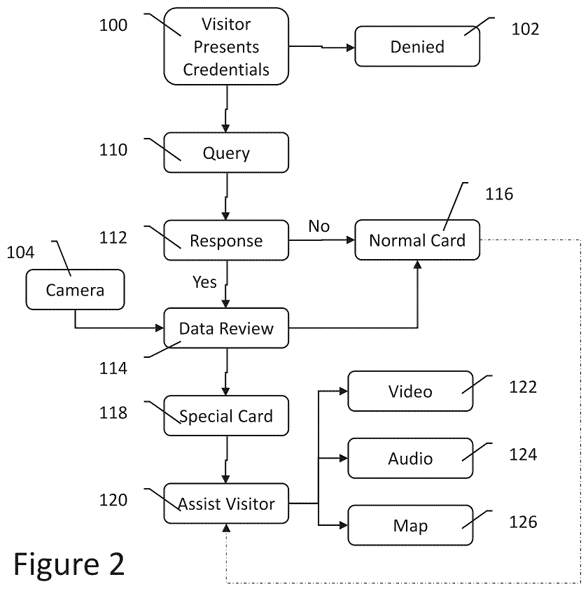

In addition, as shown in FIG. 2, the kiosk 20 may assist the visitor 10 with, for example, a video guide to the facility, an audio guide to the facility, and/or a map, any of which can be provided directly to the visitor, or which may be sent as a text message, email, or other communication to the visitor's mobile device (such as a smartphone). For example, if the visitor 10 provides information about where she is going in the building, and if the visitor is confirmed as having limited mobility, the kiosk 20 may provide a video showing how the visitor 10 may reach her intended destination in the facility using a handicapped-accessible route.

The kiosk 20 may comprise a controller and a user interface, such as a display, touchscreen, keypad, keyboard, voice activated control, microphone, camera, etc. Likewise, the PIAM system 26 may include a controller and at least communication interfaces to the other parts of the system shown in FIG. 1 and, optionally, one or more user interface hardware devices. Such a controller may take many forms, including, for example, a microcontroller or microprocessor, coupled to a memory storing readable instructions for performing methods as described herein, as well as providing configuration of the controller for the various examples that follow. The controller may include one more application-specific integrated circuits (ASIC) to provide additional or specialized functionality, such as, without limitation a signal processing ASIC that can filter received signals from one or more sensors using digital filtering techniques. Logic circuitry, state machines, and discrete or integrated circuit components may be included as well. The skilled person will recognize many different hardware implementations are available for a controller. For example, the kiosk 20 and/or PIAM system 26 may include a tablet or laptop computer, if desired.

The access card may be a physical access card. When physical access cards are to be issued, the kiosk 20 includes, for example, an encoder for writing data to a contact chip on an access card, and a slot, for example, for delivering the physical card to the user from the encoder. The contact chip of an access card may use radiofrequency identification (RFID) or near-field communication (NFC) standards and/or other technology. Data for each card may be specific to the visitor, including, for example, an identifier to allow an access log for the user to be created, and having user-specific credentials to allow visitor access to controlled spaces the credentials indicate are appropriate, and disallow access to other areas. Furthermore, there may be elements of the visitor access specific to persons having reduced mobility, for example the data written to a physical access card may indicate a time period for holding a door open is to be longer than a default period for a limited mobility person accessing the facility.

A virtual access card may be used instead. A virtual access card comprises data provided to a user device, such as a mobile phone, which can also use NFC standards to communicate credentials to access controls in the facility. Again, data may be specific to the user, including identification to allow an access log to be generated, as well as data specific to access protocols for reduced mobility users. In examples, any data that is specific to a reduced mobility user's access, as compared to access by persons who are not confirmed as having reduced mobility, makes the access credentials and the access card (whether physical or virtual) a “special”access card, as contrasted to “normal”access cards.

If, rather than an access card (virtual or physical) carried by the user, biometric access data is used, the biometric data may be communicated along with data indicating the visitor's need for accommodation. Special access rights accompanying the biometric data may, in some examples, also be deemed a special access card (if limited mobility has been confirmed), contrasted with normal access for other users lacking confirmed limited mobility. Biometric access data may be maintained within the security system, and the visitor may not have to carry either an access card nor credential information.

FIG. 2 presents steps of a method in block flow form. A visitor presents herself and/or her credentials at a security kiosk, as shown at 100. The security system compares the visitor's credentials to stored data to determine whether the visitor is authorized to access the facility. This may include determining what type of access the visitor is authorized to have. If the visitor is not authorized, access is denied 102. If the visitor is authorized, then a query is presented at 110. The query may be as simple as, “Are you physically disabled” or “Do you have difficulty with mobility,” and may be presented in more than one way (multiple languages, audio, text-based, video, etc.) if desired.

A response 112 is received from the visitor. If the response is negative, that is, the visitor indicates she is not physically disabled, a normal card is provided 116. As used herein, the card (whether normal or special) can be a physical access card, or may be a set of access credentials that can be loaded onto the visitor's mobile device (such as a smartphone). In some examples, the card is not provided to the visitor physically or virtually, but is instead stored by the PIAM system and used at each access point in the system, for example, biometric data (image, voice, etc.) can be obtained and stored and used at each access point.

If the response is positive at 112, that is, the visitor indicates she has a physical disability, is handicapped, has limited mobility, etc., data review is performed at 114. The security system may obtain additional data, such as a video feed or other visual data, to confirm whether or not the visitor is in fact physically disabled and needs the requested accommodation. Such additional data may be obtained, for example, from a security camera 104. In an example, a security camera feed, whether stored, for example, in a FIFO video loop, or obtained after the visitor requests accommodation, is analyzed using, for example, an object recognition system (to identify mobility assistance items used by the person, such as a cane, crutches, a walker or a wheelchair, etc.), and/or movement analysis system (to determine gait, speed of movement, etc.).

In some examples, an artificial intelligence (AI) may be used to determine whether or not the person is in fact physically disabled and has limited mobility. For example, to confirm whether the person is has limited mobility, the security system may use analytics and AI generated patterns. For example, the security system can match one or more captured images, or series of images (video clips) of the visitor, compare with stored patterns for physically handicapped persons, and provide a decision and/or confidence level of matching to one of the patterns. Such an AI may be trained, for example, with sets of images and/or videos of various types indicating limited mobility of various types (indicated by the visitor having a mobility assistance device and/or using analysis of how the visitor moves). That is, to confirm whether the visitor is physically handicapped or otherwise has limited mobility, some examples of the system uses analytics and AI generated patterns. For example, the security system may match one or more captured images of the visitor, and compare with all or some subset of AI generated physically handicapped people patterns. In some examples, the AI generated patterns may include some for commonly encountered patterns, for example, images of a person in a wheelchair, or images of crutches, walkers or other assistance apparatuses, which may be a readily identified assistance apparatus for persons having limited mobility. Video based metrics can be used as well, such as measurement of the visitor's gait, observing whether the user is steady or not, the speed with which the visitor moves, etc. For example, patterns of tremors associated with particular diseases, such as Parkinson's Disease or essential tremors, can be stored by the AI and/or database as patterns for AI matching purposes. Likewise, movement patterns may be developed for the AI using video or images of persons using crutches due to limb injury, etc.

If the visitor's status as physically disabled or having limited mobility is not confirmed in the data review 114, the system may generate a normal card at 116, as before. Alternatively, the visitor may be queried further by return to block 110 to, for example, seek additional information from the visitor to confirm the visitor's indicated status. If the visitor's status as physically disabled or having limited mobility is confirmed in the data review 114, a special card is generated at 118. The special card may, for example, cause the security system to hold doors open for longer periods of time, or call elevators (or hold open elevator doors) in response to visitor proximity or path. In still other examples, a visitor who indicates limited mobility but cannot be confirmed may be denied access entirely. As noted above, the special card may be a physical card, generated at an encoder for example, a virtual card communicated to a device carried by the visitor (such as a smartphone), or may be communicated by the PIAM system to access devices of the facility along with biometric data for the visitor.

The system optionally provides additional assistance to the visitor. Such assistance can include a video 122 indicating where facilities adapted for use by disabled persons are located, and/or how to access such facilities. The video 122 may instead or in addition illustrate how to travel through the building or other facility to reach an intended destination. For example, if the visitor credentials at 100 are confirmed by identifying a calendar appointment at a particular location in the facility, the video 122 may show how to access that particular location using handicapped accessible building features. Similar approaches may be used for generating an audio assistance 124 and/or a map 126. The assistance provided may come in any suitable form, such as a visual presentation or audio presentation at the kiosk itself, or as a file sent to the visitor's mobile device, such as a smartphone, via near-field communication, WiFi, text message, or email, or by any other suitable communication. Additionally or alternatively, a printed map and/or step-by-step directions may be provided, for example. The scope of assistance and/or map may be tailored to the visitors access aurhotization; for example, if the visitor is only eligible to access certain areas of the facility, and is blocked from other areas, any generated map or other assistance may be limited to the areas the visitor is authorized to access.

In another example, the query may instead be “Do you need assistance to your destination? ” in which case the response may not necessarily be an indication of physical disability, but does indicate a need for help. The system may perform data review 114 to determine physical capability of the visitor, again using, for example, camera data. Even if the visitor has not indicated a disability, the data review 114 may find that the visitor has limited mobility, and a special card at 118 can be generated, as before. If the visitor does not have limited mobility, but has indicated a need for assistance, the normal card is generated at 116, and the process may still advance to block 120 to provide assistance to the visitor to find their desired destination in the building or facility.

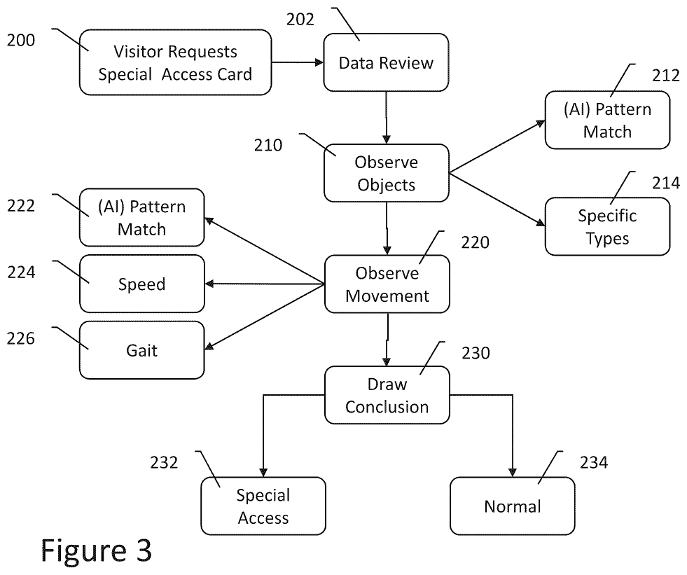

FIG. 3 illustrates in block form steps for confirming a user type. At block 200, the visitor requests a special access card. This can be performed, for example, at a kiosk at the entry to a facility, as previously described. The request may include, for example, answering one or more queries from the kiosk.

Next, video and/or other data obtained by the facility security system is analyzed as part of a data review at 202. For example, the facility may include one or more closed circuit television monitors for security purposes, referred to as a security camera herein. Security camera systems can retain video and/or audio data which will typically be stored in any suitable format such as in digital data files. The data review 202 may include identifying the visitor in the stored data, such as by object matching or pattern matching, including color and or shape to ensure that the visitor can be analyzed in each of object observation 210, and/or movement observation 220. For example, an AI-supported system can use object matching to identify the visitor based on visual characteristics matching the person who is present in front of a kiosk. If the visitor carries any identifying device, such as a badge or smartphone, signals from such device can be used to identify the visitor in the stored data.

Next, objects associated with the visitor are observed and/or analyzed. An AI pattern matching algorithm can be used, as indicated at 212. The AI pattern match may use, for example, training images of other persons of various characteristics using mobility assistance devices. Mobility assistance devices can include, throughout this and other examples herein, wheelchairs, scooters, walkers, canes, crutches, and/or prosthetic devices. Some devices may not be visible (some prosthetics) but can be confirmed in subsequent movement or gait analysis, if desired. Other items to observe may include indicators of limited movement, such as a cast, brace or sling being worn in a visible manner. A protective boot, for example, can be observed in the object recognition 210. Thus either AI pattern matching can be used, or specific object types may be stored as indicated at 214; both types of object recognition can be used as desired.

At block 220, movement is observed and analyzed. Here, again, AI-based pattern matching can be used. The AI may be trained, for example and without limitation, by using a training set of videos of movement of persons with and without movement disorders, including as desired training samples for persons using mobility assistance devices, as well as persons having casts or prosthetics who may move without the use of separate mobility assistance devices. For example, a person with a broken foot may receive a boot or cast, but may walk without use of crutches in some cases; such a person may still need added time to get through security doors. In another example, a person having a prosthetic leg may move in a specific manner than can be identified using AI-based pattern matching. While not persons having posthetics require accommodations when entering a space, however, those who do require additional time at access doors may be identified using speed and/or gait analysis at 224 or 226, or may be recognized by the AI Pattern matching 222.

In the illustrative example, both blocks 210 and 220 are present. In other examples, only one or the other may be included. The two processes, that is, observation of static objects 210 and movement characteristics 220, can be combined in a single step or process, if desired. If an answer is reached at block 210 allowing the conclusion of special access 232 (such as if a wheelchair or crutches are identified), the second process at 220 may be skipped if desired. For such an approach, block 220 may be omitted. In the alternative, only block 220 is used, and object recognition 210 using static images may be rolled into the movement analysis. For example, a movement of a wheelchair, or movement by a person using crutches, can be part of the training set for the AI, and therefore the movement based analysis would also be able to identify persons with limited mobility by virtue of identifying these objects in the video review.

Using the analysis in blocks 210 and 220, the system then draws its conclusion at 230 as to whether the visitor should receive a special access card, as indicated at 232, or not, as indicated at 234. In some examples, the kiosk may provide an indication to the visitor that a normal access card is being issued because the system could not verify a movement disorder. The visitor may be presented an additional opportunity to present a credential or other proof of limited mobility, such as allowing the user to present identification that includes indicia of limited mobility.

In an alternative example, a building may be equipped with alternative access routes. For example, a set of stairs or escalators may be available for users to reach a desired floor of the building. Elevators may be provided as well, so that users of limited mobility can reach their desired floors. In some examples, an elevator may have a security card reader and may only respond to calls (or allow floor selection) by users with special access, thus routing “normal” users to the escalators or stairs rather than the elevators. In this way, the elevator use can be limited to the special access users. For such examples, the special access allows access via one or more routes unavailable with the normal access protocol.

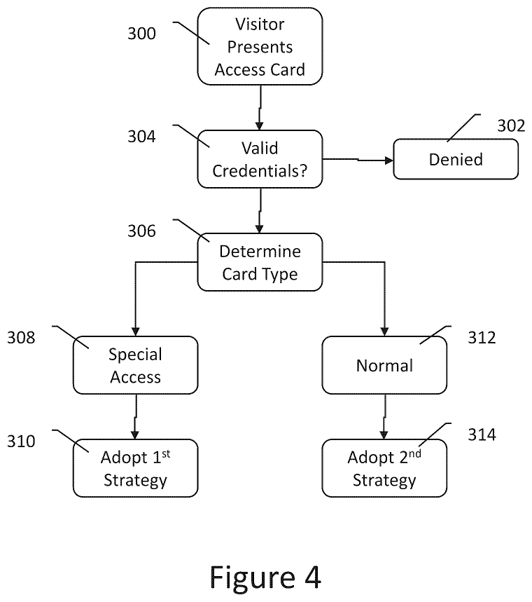

FIG. 4 illustrates in block form access control methods. At block 300, the visitor presents an access card. The access control, such as a card reader at a door, will respond to the presented access card by validating the credentials of the user at 304. Credential validation 304 may include comparison of the presented credentials to stored data. If the credentials are not valid, access is denied at 302.

If the credentials are valid, the system then determines the card type at 306. If a special access card has been presented, as indicated at 308, the access control adopts first strategy for the visitor, as indicated at 310. This may include holding a door or gate open, or opening an elevator, for a first, relatively longer period of time. Other modifications can be made, such as slowing an escalator, or anticipating movement of the by calling an elevator to a nearby set of elevators to allow the person ready access to the elevator (rather than an escalator or stairs). Any of these can be a “first strategy” applied when the visitor presents a special access card at 308.

If a normal access card is presented, at 312, then a second strategy for access is adopted, as indicated at 314. This may include holding a door or gate open, or opening an elevator, for a second, relatively shorter period of time. Other facility features, such as an escalator or elevator, may operate in normal fashion, as desired.

In some examples, a security system may include a kiosk 20 (FIG. 1), configured for receiving and verifying credentials and issuing access cards, the kiosk having or in communicative link to database 24 (FIG. 1) for facility data and a controller or PIAM system 26 (FIG. 1) configured to perform analysis functions. The system may include a camera 22 (FIG. 1) for observing a visitor 10 (FIG. 1); and at least one access control 30 (FIG. 1); the security system configured for: receiving, at the kiosk, a set of access credentials from a visitor 100 (FIG. 2); accepting the access credentials to grant access to a limited access area if the access credentials are valid (path from 100 to 110 in FIG. 2); presenting, from the kiosk, a query to the visitor asking whether the visitor has impaired mobility 110 (FIG. 2); receiving, at the kiosk, a response from the visitor to the query asking whether the visitor has impaired mobility 112 (FIG. 2); if the visitor gave a negative response, issuing a normal access card for the visitor 116 (FIG. 2), or, if the visitor gave an affirmative response, next confirming, by analysis of data from the camera, whether the visitor has impaired mobility 114 (FIG. 2); and if the visitor is confirmed to have impaired mobility, configuring a special access card for the visitor and issuing the special access card for the visitor 118 (FIG. 2). In the example, the visitor may later present the access card at an access control 300 (FIG. 4), wherein the access control controls opening a door, holding the door open for a predetermined period of time, and closing the door. The access control responds to the special access card by using a first predetermined period of time and the access control responds to the normal access card by using a second predetermined period of time, the second predetermined period of time being shorter than the first predetermined period of time. FIG. 4, at 304, shows that the access control determines if presented credentials are valid at 304, and then determines the card type at 306. If the access card is found to be a special access card 308, a first access control strategy is adopted 310. If the access card is found to be a normal access card 312, then a second access control strategy is adopted 314.

It may be noted that an alternative would be to hold open all doors, for example, for the longer period of time provided for special access cards. This, however, may be considered a security risk as holding a door open longer than needed for most users to pass can allow unauthorized access, for example. As a result, it is desirable to have a default opening period (or other access parameter) that is configured to maintain a desired level of security, while also providing special access to those needing more time. Placed in context, the visitor will already have been acknowledged as an authorized person to access the facility, and the assessment of limited mobility only takes place when the user so requested. Thus there is no invasion of privacy in performing these analyses; rather the question is whether adverse effects on system-wide security by holding doors open longer than a default period is justified by the user's request for special access.

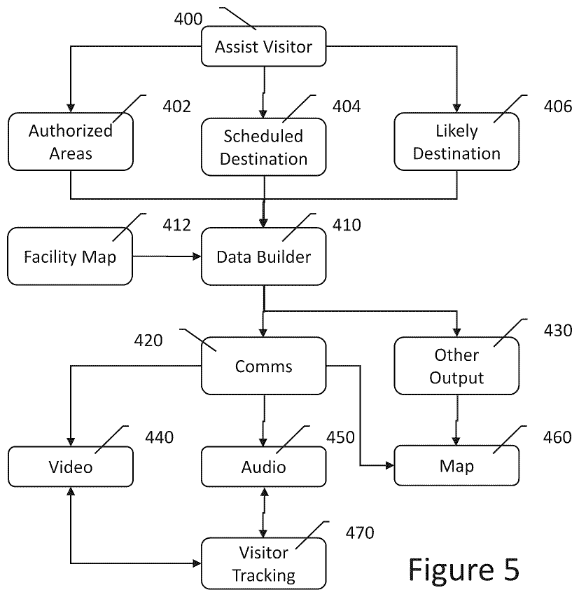

FIG. 5 illustrates in block form a method for visitor assistance. Once the system determines the user is authorized for special access (optionally; the method of FIG. 5 may also be used independent of the determination of special access), the data builder 410 is populated with a set of expectations regarding the visitor's use of the facility. For example, authorized areas that the visitor can go to, based on the visitor's credentials, may be determined at 402. If an integrated PIAM system is able to access calendar information, or if an indication that the visitor has a specific appointment or location to go to is obtained via the kiosk, a scheduled destination 404 may be determined. In some examples, likely destination 406 may be estimated by, for example, cross-referencing the visitors access credentials with other information to determine a likely destination. For example, in a manufacturing facility, if a quality assurance consultant presents their credentials at the kiosk, and, in response, the likely destination 407 may be the area of the quality assurance office(s) in the facility.

The authorized areas, scheduled destination or likely destination are provided to a data builder 410. The data builder obtains building data, such as the facility map 412, and generates a set of output data including any identified path. If, for example, there are multiple ways to reach a particular scheduled or likely destination, a path which is easiest to access for a person of limited mobility may be identified, and serves as the basis for generating a map 460, audio directions 450, or video directions 440.

The output of the data builder 410 is directed via a communications block 420 to any suitable device. For example, an output may be sent to a smartphone the visitor possesses, and so the communications block 420 may have WiFi, Bluetooth, or other wireless communications capability. In another example, one or more intermediate points in a facility may have audio devices that can provide instructions to the visitor, and the communications block sends messages by wire, or by wireless communications, to the audio devices. For example, when the visitor passes through an access point, an audio direction may be issued. An example may be that, as the visitor passes by an access point or assistance device, an audible output is provided: “Turn Left, go to the third door on the right and enter. ” The communications block 420 may, for example, communicate video direction 440, audio directions 450, or a map as a readable file to be accessed by the visitor's smartphone, for example.

The visitor may be tracked, as indicated at 470, as they traverse the facility. Such tracking 470 may allow for updated directions to be communicated as needed. The visitor may be presented with the option to turn off tracking, if required by local regulations or if otherwise desired.

Physical outputs can also be generated. For example, the other output block at 430 may indicate a printer that outputs a printed map and/or printed instructions at the kiosk, which are provided to the visitor. In some examples, the output may be an audio device that is intended to be received and carried by the visitor, and the “other output” 430 encodes the audio device before it is issued to the visitor. The audio device can then be provided to the visitor at the kiosk. An example audio device may include a personal digital assistant carried on a lanyard, for wearing on the chest of the visitor and having a speaker for providing audio instructions; or, alternatively, a headset or ear bud.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments. These embodiments are also referred to herein as “examples. ” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more. ” Moreover, in the claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic or optical disks, magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims.

Also, in the above Detailed Description, various features may be grouped together to streamline the disclosure. This should not be interpreted as intending that an unclaimed disclosed feature is essential to any claim. Rather, innovative subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the protection should be determined with reference to the appended claims, along with the full scope of equivalents to which such claims are entitled.

What is claimed is:

1. A security system comprising:
a kiosk configured for receiving and verifying credentials and issuing access cards, the kiosk having or in communicative link to database for facility data and a controller configured to perform analysis functions;
a camera for observing a visitor; and
at least one access control; the security system configured for:
receiving, at the kiosk, a set of access credentials from a visitor;
accepting the access credentials to grant access to a limited access area if the access credentials are valid;
presenting, from the kiosk, a query to the visitor asking whether the visitor has impaired mobility;
receiving, at the kiosk, a response from the visitor to the query asking whether the visitor has impaired mobility;
if the visitor gave a negative response, issuing a normal access card for the visitor;
if the visitor gave an affirmative response, next confirming, by analysis of data from the camera, whether the visitor has impaired mobility; and
if the visitor is confirmed to have impaired mobility, configuring a special access card for the visitor and issuing the special access card for the visitor;
wherein the access control controls opening a door, holding the door open for a predetermined period of time, and closing the door;
wherein the access control responds to the special access card by using a first predetermined period of time and the access control responds to the normal access card by using a second predetermined period of time, the second predetermined period of time being shorter than the first predetermined period of time.

2. The security system of claim 1, further comprising, if the visitor is confirmed to have impaired mobility, generating and communicating to the visitor a video illustrating a manner of accessing and passing through the limited access area tailored to the visitor having impaired mobility.

3. The security system of claim 1, wherein the security system is configured to use an artificial intelligence to analyze the data from the camera to confirm whether the visitor has impaired mobility.

4. The security system of claim 1, wherein the security system is configured to use an object recognition to analyze the data from the camera to confirm whether the visitor has impaired mobility, the object recognition configured to identify a mobility assistance device.

5. The security system of claim 1, wherein the security system is configured to analyze one or more of gait or speed of the visitor using the data from the camera to confirm whether the visitor has impaired mobility.

6. The security system of claim 1, wherein the security system is configured to issue the normal access card in response to the visitor giving an affirmative response to the query and the security system not confirming that the visitor has impaired mobility.

7. The security system of claim 1, wherein the special access card is a physical access card, and the kiosk includes an encoder for writing data to the physical access card.

8. The security system of claim 1, wherein the special access card is a virtual access card, and the kiosk is configured to communicate credentials for the special access card to a mobile device of the visitor.

9. The security system of claim 1, wherein the special access card takes the form of data accompanying biometric data of the visitor, and the kiosk is configured to issue the special access card for the visitor by communicating the biometric data and special access data for the visitor to the access control.

10. A method of operating a security system comprising:
receiving a set of access credentials from a visitor;
accepting the access credentials;
presenting a query to the visitor asking whether the visitor has impaired mobility;
receiving a response from the visitor indicating impaired mobility;
in response to the visitor indicating impaired mobility, next analyzing whether the visitor has impaired mobility by analysis of data from a security camera;
confirming the visitor has impaired mobility and, in response, configuring a special access card for the visitor and issuing the special access card for the visitor;
receiving, at an access control, a request to access from the visitor to whom the special access card was issued, wherein the access control controls:
opening a door;
holding the door open for a first predetermined period of time for a normal access card, or holding the door open for a second predetermined period of time for the special access card, the second predetermined period of time being longer than the first predetermined period of time; and
closing the door; and
the access control opening the door for the second predetermined period of time in response to the visitor's request for access.

11. The method of claim 10, further comprising, along with issuing the special access card to the visitor, generating and communicating to the visitor a video illustrating a manner of accessing and passing through the limited access area tailored to the visitor having impaired mobility.

12. The method of claim 10, wherein the step of analyzing whether the visitor has impaired mobility is performed by using an artificial intelligence for pattern recognition.

13. The method of claim 10, wherein the step of analyzing whether the visitor has impaired mobility is performed by object recognition configured to identify a mobility assistance device.

14. The method of claim 10, wherein the step of analyzing whether the visitor has impaired mobility is performed by analyzing one or more of gait or speed of the visitor using the data from the camera.

15. The method of claim 10, wherein the special access card is a physical access card, and the method further comprises using an encoder to write data to the physical access card to make the physical access card a special access card.

16. The method of claim 10, wherein the special access card is a virtual access card, and the method further comprises communicating for the special access card to a mobile device of the visitor.

17. The method of claim 10, wherein the special access card takes the form of data accompanying biometric data of the visitor, and the method further comprises communicating the biometric data and special access data for the visitor to the access control.

18. A non-transitory computer readable medium storing instructions for execution by a security system comprising a kiosk configured for receiving and verifying credentials and issuing access cards, the kiosk having or in communicative link to database for facility data and a controller configured to perform analysis functions, a camera for observing a visitor, and at least one access control; the instructions, when executed, causing the system to:
receive, at the kiosk, a set of access credentials from a visitor;
accept the access credentials to grant access to a limited access area if the access credentials are valid;
present, from the kiosk, a query to the visitor asking whether the visitor has impaired mobility;
receive, at the kiosk, a response from the visitor to the query asking whether the visitor has impaired mobility;
if the visitor gave a negative response, issuing a normal access card for the visitor;
if the visitor gave an affirmative response, next confirm, by analysis of data from the camera, whether the visitor has impaired mobility; and
if the visitor is confirmed to have impaired mobility, configure a special access card for the visitor and issue the special access card for the visitor;
wherein the access control controls opening a door, holding the door open for a predetermined period of time, and closing the door;
wherein the access control responds to the special access card by using a first predetermined period of time and the access control responds to the normal access card by using a second predetermined period of time, the second predetermined period of time being shorter than the first predetermined period of time.

19. The non-transitory computer readable medium of claim 18, wherein the instructions, when executed, further cause the system to generate and communicate to the visitor a video illustrating a manner of accessing and passing through the limited access area tailored to the visitor having impaired mobility if the visitor is confirmed to have impaired mobility.

20. The non-transitory computer readable medium of claim 18, wherein the instructions when executed, cause the security system to use an artificial intelligence to analyze the data from the camera to confirm whether the visitor has impaired mobility.
